(19) United States
(12) Patent Application Publication
(10) Pub. No.: US 2019/0079948 A1
(43) Pub. Date: Mar. 14, 2019

(54) DIRECTORY TREE CLONES

(71) Applicant: Hewlett Packard Enterprise Development LP, Houston, TX (US)

(72) Inventors: Manny Ye, Andover, MA (US); Padmanabhan S. Nagarajan, Tewksbury, MA (US); Marcelo Bandeira Condotta, Andover, MA (US)

(21) Appl. No.: 15/704,340

(22) Filed: Sep. 14, 2017

(51) Int. Cl. G06F 17/30

(52) U.S. Cl. CPC G06F 17/30168; G06F 17/30194; G06F 17/30088

(57) ABSTRACT

Examples described herein include receiving a request for a clone of a directory tree in a distributed file system for the directory tree at a first point in time. Examples described herein also include generating a copy of an inode data and determining a relevancy of the clone based on a birth epoch and a death epoch of a first entry in the inode data. The inode data may describe a root of the directory tree at a second point in time.

### BACKGROUND

A directory tree of a filesystem is a hierarchal structure that shows the relationship of files and directories within a filesystem. A directory tree clone may represent a copy of a directory tree. In some examples, directory tree clones may allow users to access their own version of a directory tree, leading to versatility of the filesystem.

### BRIEF DESCRIPTION OF THE DRAWINGS

The following detailed description references the drawings, wherein:

FIG. 1 is a block diagram of a computing device with instructions to done a directory tree, according to some examples.

FIG. 2A is a block diagram of a directory tree, according to some examples.

FIG. 2B is a block diagram of inode data associated with the directory tree shown in FIG. 2A, according to some examples.

FIG. 2C is a diagram of a clone line of directory tree clones, including a current clone, an origin, and a grand origin, according to some examples.

FIG. 2D is a diagram of a clone line of directory tree clones, including a current clone, a parent origin, a grand origin, and a great-grand origin, according to some examples.

FIG. 3 is a block diagram of a computing system with a directory tree and an engine to clone the directory tree, according to some examples.

FIG. 4 is a block diagram of a computing system comprising the directory tree of FIG. 2A, according to some examples.

FIG. 5 is a flowchart of a method of generating a clone of a directory tree, according to some examples.

FIG. 6 is a flowchart of a method of determining a relevancy of entries in the inode data, according to some examples.

### DETAILED DESCRIPTION

In some examples, a filesystem may be implemented as a write-in-place (WIP) filesystem. In WIP filesystems, existing data is overwritten when the data is updated. In other words, a copy of the old data is not made before the old data is overwritten. As discussed above, in some examples, applications and/or users may want to access and modify a directory tree of the filesystem. In some examples, two different applications and/or users may want to modify the same directory tree in different manners. Additionally, the application and/or user may want to access an older version of the directory tree rather than the directory tree as it currently exists (i.e., the “live” directory tree).

While a WIP architecture may conserve the underlying disk storage space used by the filesystem, the WIP process of overwriting data blocks may make it difficult to provide users with versatile writeable directory tree clones. This is because old data is overwritten upon an update and, thus, the data as it currently exists represents a “live” version of the directory tree. Merely copying the existing data for the directory tree provides a “live” version of the directory tree, which may not be the version that the application or user needs. Additionally, merely copying the existing data may incur filesystem performance penalties and delays as a directory tree may include numerous directories, subdirectories, and files. Additionally, merely copying the existing data would also incur space penalties in the underlying disk storage space.

Examples disclosed herein allow a computing system to generate writeable clones of directory trees while reducing time and space penalties in the operation of the filesystem. Examples disclosed herein also allow a computing system to generate writeable clones of older versions of directory trees. In some examples, the computing system generates a copy of the root inode data of the directory tree and determines a relevance of the entries in the root inode data. The copy of the root inode data is modified to remove entries that are determined to be irrelevant for the requested directory tree clone. In some examples, the computing system may read and access the inode data of a directory and/or subdirectory of the directory tree without copying it. The computing system may determine a relevance of the entries in the accessed inode data and filter out entries that are determined to be irrelevant to the requested directory tree clone. Thus, examples disclosed herein allow a computing system to generate a clone of a directory tree efficiently.

In some examples, a computing device is provided with a non-transitory machine-readable storage medium. The non-transitory machine-readable storage medium comprises instructions, that, when executed, cause a processing resource to receive a request for a clone of a directory tree in a distributed file system. The clone request may be for the directory tree at a first point in time. The instructions, when executed, cause the processing resource to generate a copy of an inode data. The inode data describes a root of the directory tree at a second point in time and comprises a first entry. Additionally, the instructions, when executed, cause the processing resource to determine a relevancy of the first entry to the clone based on a birth epoch and a death epoch of the first entry.

In some examples, a computing device comprises a memory and a transformation engine. The memory may store a first inode data and a second inode data of a directory tree. The first inode data may describe a root of the directory tree and comprise a first entry, and the second inode data may describe a first portion of the directory tree. The transformation engine is to receive a request for a clone of the directory tree, generate a copy of the first inode data, and determine a relevancy of the first entry to the clone based on a birth epoch and a death epoch of the first entry. The request is for the directory tree at a second point in time.

In some examples, a method is provided, including receiving a request for a clone of a directory tree in a distributed file system and generating a copy of a first inode data. The request is for the directory tree at the first point in time and the first inode data describes a root of the directory tree at a second point in time and comprises a first entry. The method also includes determining a first relevancy of the first entry to the clone based on a creation epoch associated with the first point in time, modifying the copy of the first inode data based on the first relevancy determination, and reading a second inode data. The second inode data describes a subdirectory of the directory tree and comprises a second entry. The method includes determining a second relevancy of the second entry to the clone based on a modified creation epoch and filtering the second inode data based on the second relevancy determination.

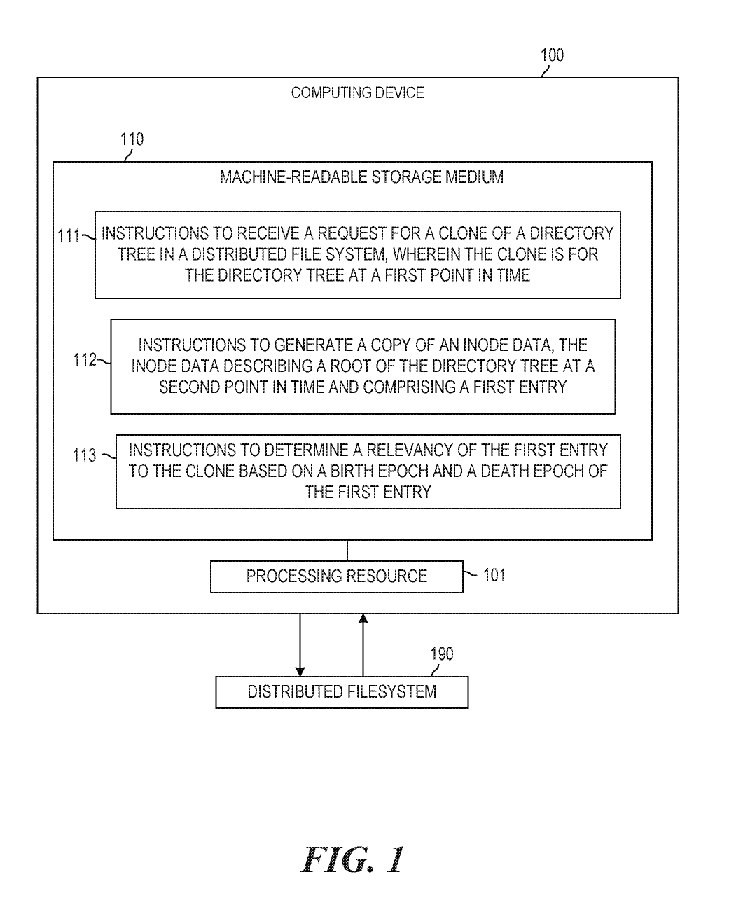

Referring now to the figures, FIG. 1 is a block diagram of a computing device 100 with instructions thereon to clone a directory tree. As used herein, a “computing device” may be a server, computer networking device (e.g., switch), a storage device, chip set, desktop computer, workstation, personal device, etc., or any other processing device or equipment.

Computing device 100 includes a processing resource 101 and a machine-readable storage medium 110. Machine-readable storage medium 110 may be in the form of non-transitory machine-readable storage medium, such as suitable electronic, magnetic, optical, or other physical storage apparatus to contain or store information such as instructions 111, 112, 113, related data, and the like.

As used herein, “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, a storage medium may correspond to memory including a main memory, such as a Random Access Memory, where software may reside during runtime, and/or a secondary memory. The secondary memory can, for example, include a non-volatile memory where a copy of software or other data is stored.

In the example of FIG. 1, instructions 111, 112, and 113, are stored (e.g., encoded) on storage medium 110 and are executable by processing resource 101 to implement functionalities described herein in relation to FIG. 1. In some examples, the functionalities of any of the instructions of storage medium 110 may be implemented in the form of electronic circuitry, in the form of executable instructions encoded on machine-readable storage medium, or a combination thereof.

Processing resource 101 may, for example, be in the form of a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. The processing resource can, for example, include single or multiple cores on a chip, multiple cores across multiple chips, multiple cores across multiple devices, or suitable combinations thereof. The processing resource can be functional to fetch, decode, and execute instructions 111, 112, and 113 as described herein.

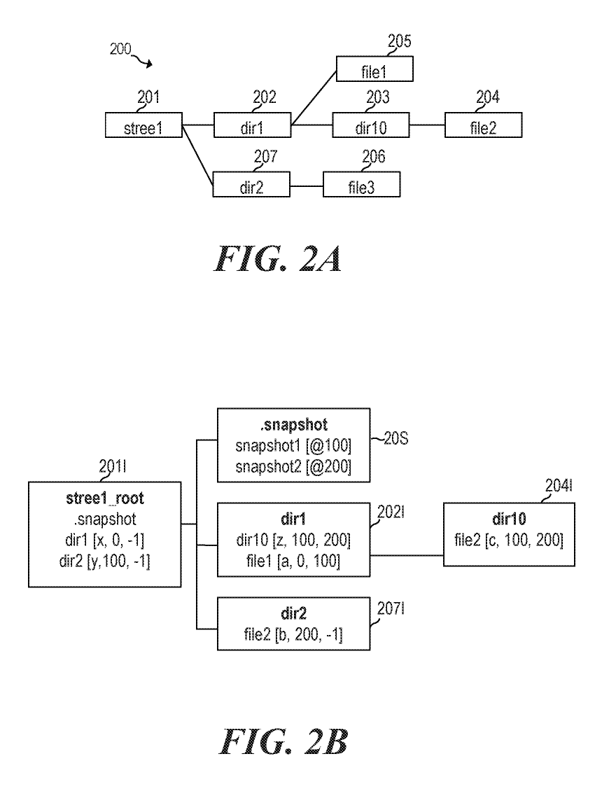

Instructions 111 may be executable by processing resource 101 to receive a request for a clone of a directory tree. In some examples, the directory tree may be part of a distributed file system 190. As used herein, a directory tree is a cataloging structure that allows data to be tied to other data in a hierarchal manner. A directory tree may have a root, directories, and subdirectories. Files may also reside underneath the root. FIG. 2A illustrates an example of a directory tree 200. Directory tree 200 has a root stree1 at 201 with two directories dir1 and dir2, at 202 and 207, respectively. Dir1 at 202 has file1 at 205 and sub-directory dir10 at 203. Sub-directory dir10 subsequently has file2 at 204. Dir2 at 207 has file3 at 206. Directory tree 200 may be in a distributed filesystem. Thus, referring back to FIG. 1, for example, instructions 111 may receive a request for a clone of directory tree 200 that is part of distributed filesystem 190.

The data stored in a distributed file system may be hosted at a number of remote locations (not shown in FIG. 1). For example, data associated with a first file in a folder of the distributed file system may be stored on a computing device (e.g., server) at one location and data associated with a second file in the same folder may be stored on a computing device at another location. However, a distributed file system allows a user accessing the first and second files to view these items as being in the same folder, regardless of where the underlying data is stored. In other words, a distributed file system allows the organization of data residing at different locations into a hierarchal structure and allows a user to access the data in the hierarchal manner as if the data were residing locally on the user's computing device.

The request received by instructions 111 may include a signal indicating to computing device 100 that a user or an application desires a clone of a directory tree of distributed filesystem 190. Accordingly, the request may come from a computing device that is different from computing device 100 or may originate from computing device 100. In some examples, the request may be a request that directly asks for a clone of the directory tree.

In some examples, the request is for a clone of the directory tree as the directory existed at a certain point in time (i.e. requested point in time). As used herein, a “point in time” refers to a discrete point in a time. Thus, a “first” point in time may refer to a discrete point in time, and a “second” point in time may refer to another (i.e., different) discrete point in time. A “first” point in time may come before or after a “second” point in time. Additionally, in some examples, there may be another point in time between the “first” point in time and the “second” point time. In other examples, the “first” point in time and the “second” point in time may be sequential.

In some examples, the directory tree at the first point in time may be captured by a snapshot. The snapshot is linked to the first point in time through a creation time value. This creation time value may be an alphanumeric characteristic used by the computing device 100 to label the point in time at which the snapshot is generated. In some examples, the creation time value may include a creation epoch. An epoch may be a monotonically increasing number that is used by the computing device 100 to keep track of elapsed time from a common point. Specific events may be identified with specific epochs. The snapshot may thus be linked to a creation epoch value that labels the snapshot as being created at the first point in time. For example, an epoch of computing device 100 may start at a common point of epoch value 0. After a specific unit of time period elapses, the epoch increases. Thus, a snapshot that has a creation epoch of 100 was created at a point in time that is 100 units away from epoch 0. A snapshot that has a creation epoch of 200 was created at a point in time 100 units after creation epoch 100. A snapshot that has a creation epoch of 50 was created at a point in time 50 units before creation epoch 100.

Distributed file system 190 may include inodes. An inode is data that describes a directory or a file of distributed file system 190. The inode for a particular file or directory may include the metadata for that particular file or directory, including, but not limited to user permissions, an inode identification, a directory tree identification, an inode number, etc. The inode identification may be a unique characteristic that identifies the inode to the computing system 100. The directory tree identification may be a unique characteristic that identifies which directory tree this inode is for, and the inode number may point to an inode data. The inode data may be stored in another location than where the inode is stored and includes the underlying data for that file or directory.

The inode data of a directory may include a first entry that identifies a file or a subdirectory in the directory. In some examples, the first entry may include an inode number, an object name, a birth time value, and a death time value. The inode number may point to another inode data where the underlying data for the first entry is stored. The object name may indicate a name that has been assigned to the first entry, such as “foo” or “bar”. A birth time value may be an alphanumeric characteristic used by the computing device 100 to label the time at which the first entry was created. A death time value may also be an alphanumeric characteristic used by the computing device 100 to label the time at which the first entry was modified or deleted. The birth time value and the death time value may indicate how much time has passed in relation to each other and in relation to the creation time value (as discussed above in relation to the first point in time). Accordingly, in some examples, the birth time value and death time value may also be based on an already existing creation epoch. For example, an entry describing a directory may have the creation epoch of the most current snapshot as the entry's birth epoch.

FIG. 2B shows an example of inode data that is associated with directory tree 200 of FIG. 2A. 201l is the inode data for the root stree1 of directory tree 200. As seen in inode data 201l, the root stree1 has two entries, one entry for dir1 and another entry for dir2. Each entry in inode data 201l has an inode number, an object name, a birth epoch, and a death epoch. For example, the first entry has an object name “dir1”, a birth epoch of 0, a death epoch of −1, and an inode number of x. Inode number “x” is a pointer that points to inode data 202l. 202l describes the content of dir1 and includes an entry for dir10 and file1. 207l describes the content of dir2 and includes an entry for file2. It is pointed to by the inode number “y” in 201l. 204l is the inode data for dir10. The inode number in 202l for dir10 “z” may point to the inode data 204l. As shown in FIG. 2B, directory tree 200 may also have snapshots that are taken of it. Thus, inode data 201l has an entry for the snapshots at 20S. The inode data 20S includes entries for snapshot1 and snapshot2. Snapshot1 has a creation time value of 100 and snapshot2 has a creation time value of 200. The underlying inode data for file1 and file2 is not shown in FIG. 2B.

Referring back to FIG. 1, instructions 112 may be executable by processing resource 101 to generate a copy of an inode data of the directory tree. The inode data may describe a root of the directory tree. As used herein, the root of a directory tree is the highest level of the directory tree. For example, in a directory tree with three levels, a first level, a second level, and a third level, the root of the directory tree is the first level. Thus, in the example of FIG. 2B, instructions 112 may generate a copy of 201l.

As discussed above, the request received is for a clone that represents the directory tree as it existed at a certain point in time (i.e. requested point in time), but in response, the copy is made at a point in time that different from the certain point in time (i.e. later point in time). As such, the copy may not represent the directory tree as it existed at the requested point in time. This is because, in some examples, modifications made to the directory are captured in the inode data without first creating a copy of the unmodified inode data. Accordingly, the inode data that describes the directory tree at the later point in time may be different from the inode data that describes the directory tree at the requested point in time.

For example, referring to FIGS. 2A and 2B, a user may make a request at epoch 300 for a clone of directory tree 200 as it existed at snapshot1. Snapshot1 has a creation epoch of 100 (represented in FIG. 2B as @100.). The entry for dir2 has a birth epoch of 100, which is the creation epoch of snapshot1. Because entries may take the creation epoch of the snapshot that occurred most recently prior to the entry creation as the entry's birth epoch, this indicates that dir2 was created after snapshot1. At epoch 100, the inode data for the directory does not have an entry for dir2. It is only when dir2 is created that the inode data 201l is modified to include an entry for dir2. At epoch 300 (when the user requests a clone), the inode data for the directory tree has an entry for dir2. The inode data that is copied at epoch 300 also has an entry for dir2, even though dir2 did not exist at snapshot1 and is not supposed to exist in the requested clone. Thus, the inode data that is cloned describes the directory tree at a point in time that is different than the first point in time.

In this example, the point in time for the clone (requested point in time) is referred to as a “first” point in time. Thus, the point in time of the inode data (later point in time) may be characterized as a “second” point in time. While in this example, “first” is used to refer to the requested point in time, in other examples, “first” may be used to refer to a point in time that is not the requested point in time (e.g., “first” may be used to refer to the later point in time). Additionally, in this example, “second” is used to refer to the later point in time, but in other examples, “second” may be used to refer to a point in time that is not the later point in time (e.g., “second” may be used to refer to the requested point in time).

Referring back to FIG. 1, instructions 113 may be executable by processing resource 101 to determine a relevancy of an entry in the inode data to the clone. In some examples, this determination may be based, at least in part, on the birth time value and the death time value of the first entry. As noted above, a clone is to represent a directory tree as it existed at a requested point in time. A given entry may be relevant to a given clone when the given entry existed in the directory tree at the requested point in time. A given entry may not be relevant to a given clone when the given entry did not exist in the directory tree at the requested point in time. In examples described herein, a determination of the relevancy of a given entry to a given clone to represent a directory tree at a requested point in time may include a determination of whether or not the given entry, as it exists in a copy of inode data, was included in the inode data of the directory tree as the directory tree existed at the requested point in time.

In some examples, a relevancy determination may be made via a comparison of the birth time value of the first entry with the creation time value associated with the first point in time. For example, if the birth time value of the first entry represents a time that is later than the time of the creation time value, then the first entry is not relevant to the clone because the file or directory associated with the first entry was created after the first point in time. As another example, if the birth time value of the first entry represents a time that is earlier than the time of the creation time value, then the first entry is relevant to the clone because it was created before the first point in time. Thus, in the example of FIG. 2B, dir2 would not be relevant to a clone of directory tree 200 based on snapshot1 because dir2 was created after snapshot1. In contrast, dir1 is relevant to the clone because dir1 (with a creation epoch of 0) was created before snapshot1.

In some examples, a relevancy determination may be made via a comparison of the death time value of the first entry with the creation time value associated with the first point in time. For example, if the death time value of the first entry represents a time that is before the time of the creation time value, then the first entry is not relevant to the clone because the file or the directory associated with the first entry was inactive before the first point in time. As used herein, an inactive entry includes an entry that represents a file or directory that has been changed since it was created. Thus, the file or directory that the entry represents may have been deleted from the directory or moved from the original location in the directory tree since the file or directory was created. As another example, if the death time value of the first entry represents a time that is later than the time of the creation time value, or if the death time value of the first entry represents that the entry has not been inactivated, then the first entry is relevant to the clone because it was still in existence at the first point in time. Thus, in the example of FIG. 2B, file1 would not be relevant to a clone of directory tree 200 from snapshot2 because file1 was deleted before snapshot2 was created.

In some examples, instructions 113 may include instructions, that, when executed by processing resource 101, cause computing device 100 to modify the inode data copy based on the relevancy determination. In examples where the first entry is determined not to be relevant to the clone, the inode data copy may be modified such that the first entry is removed from the copy.

Additionally, instructions 113 may include instructions to modify the birth and/or death time values of the first entry. For example, a birth time value of the first entry may indicate that the first entry was created before the first point in time. Thus, the first entry is relevant to the clone and is retained in the inode data copy. However, a death time value of the first entry may indicate that the first entry is no longer active in the current live view of the directory tree. If the first entry is kept exactly the same in the inode data copy, then the clone would incorrectly show that the first entry is no longer active. Thus, the instructions may cause computing device 100 to modify the death time value of the first entry in the copy of the inode data to indicate that it is alive. In some examples, this is characterized as reviving the first entry.

The root of a directory tree may have a number of entries. For example, the directory tree may have a second entry, a third entry, a fourth entry, etc. in addition to the first entry. Instructions 113 may be executable by processing resource 101 such that computing device 100 determines a relevancy of all of the entries in the inode data of the root. In other examples, instructions 113 may be executable by processing resource 101 such that computing device 100 determines a relevancy of some of the entries in the inode data of the root. As used herein, a “first” entry and a “second” entry may or may not coincide with the hierarchal structure of the entries in the directory. Additionally, a first entry and second entry may or may not coincide with the order in which the entries were created. Thus, as used herein, a “first entry” and a “second entry” are used to indicate one entry that is different from to the other entry.

As shown in FIG. 2A, a directory tree root may have many directories (e.g., dir1 and dir2) and subdirectories (e.g., dir10) under those directories. Each directory and subdirectory in those directories may have its own inode data to describe the particular directory and subdirectory. Accordingly, in some examples, storage medium 110 may include additional instructions not shown in FIG. 1 that may be executed to generate the directory tree clone.

For example, storage medium 110 may include instructions, that, when executed, cause the processing resource 101 to generate a copy of an inode data that describes a directory of the directory tree. The directory may be one of the directories described by an entry in the root inode data. The inode data that describes the directory may include entries that describe files or subdirectories in the directory. Each entry may have its own birth epochs and death epochs. For example, in the context of FIG. 2B, this would include 202l, 207l, and/or 204l. In some examples, storage medium may 110 may include instructions, that, when executed, cause the processing resource to generate a copy of all inode data for all directories and subdirectories of the directory tree, determine the relevancy of all entries in the inode data, and modify the copies based on the relevancy determination. In these examples, the inode data for all portions of the directory tree is copied.

In some examples, storage medium 110 may include instructions that, when executed, cause the processing resource 101 to read an inode data that describes a directory or a subdirectory of the directory tree. Thus, instead of copying all of the inode data for all portions of the directory tree, only some inode data is copied and the rest is read. In some examples, this may be done for directories or subdirectories that are not modified by the clone. For example, in FIG. 2B, a directory 200 has two directories dir1 and dir2. A user creating the clone may need to modify dir1 but only view dir2. Instructions in storage medium 110 are executed by processing resource 101 to allow computing device 100 to access and read the inode data of the unmodified directory portions instead of needing to copy the data. Thus, in the context of FIG. 2B, processing resource 101 reads 207l to generate a clone and does not need to make a copy of 207l. This may allow for more efficient process in creating the clone of the directory tree 200 than if both directories had to be copied.

However, the inode data that is read may not accurately describe the directory tree at the first point in time. For example, the data may describe the directory tree as it exists in the directory tree that it is being cloned from. Thus, storage medium 110 may also include instructions to determine a relevancy of the entries in the inode data to the current clone. In some examples, the relevancy may be determined based on a birth time value of the entry in the inode data, a death time value of the entry in the inode data, and a modified creation time value associated with the first point in time (requested point in time).

Because the inode data that is being accessed was not generated for the current clone, the creation epoch associated with the first point in time (requested point in time) may not be an accurate filter from which to read the entries in the inode data. Accordingly, in some examples, instructions in storage medium 110 may determine a modified creation epoch. As discussed above, an inode may include metadata for that inode, including a tree identification that identifies which directory tree the inode data is for. Additionally, because a directory tree may be a clone of another directory tree, the inode may be associated with an origin identification which identifies which tree the current directory tree was cloned from, if any. This origin identification may be stored in a separate table that may be accessed. The origin identification may also be associated with an origin epoch, which labels when the origin directory tree was created. Thus, computing system 100 may have access to a table that associates a directory tree to its origin directory tree and associates an origin directory tree to an origin time value.

The modified creation epoch for filtering through the inode data may be based, at least in part, on a comparison of the tree identification that is listed in the inode data with the identification of the current directory tree clone. Based on a determination that the inode data tree identification is the same as the identification of the current directory tree clone, the creation epoch associated with the current clone may be used as the modified creation epoch for filtering the inode data. However, based on a determination that the inode data tree identification is not the same as the identification of the current directory tree clone, processing resource 101 looks at the origin identification for the current directory tree clone. In other words, it looks to what directory tree the current clone is cloned from. It then compares the origin identification with the tree identification (as listed in the inode data). Based on a determination that the inode tree identification is the same as the origin identification, processing resource 101 uses the origin time value as the modified creation time value. However, based on a determination that the tree identification (as listed in the inode data) is not the same as the origin identification, instructions stored on the storage medium 101 will cause processing resource 101 to look at the origin identification of the origin directory tree (i.e. the “grand origin” of the current clone). Based on a determination that the tree identification (as listed in the inode data) is the same as the origin identification of the origin directory tree, instructions will cause processing resource 101 to use that origin time value (i.e. the origin time value of the grand origin of the current clone) as the modified creation time value.

FIGS. 2C and 2D illustrate examples of determining a modified creation epoch. In FIG. 2C, the current clone stree1clone2 is represented by portion C with block 211C. The “origin” of the current clone is represented by portion B with block 211B, and the “grand origin” of the current clone is represented by portion A with block 211A. A user of clone stree1clone2 is trying to view dir2 of directory tree 200 but is not modifying dir2. Accordingly, instead of copying the inode data 212B for dir2, instructions on computing device 100 may cause processing resource 101 to access and read inode data 212B to provide the user of clone 211C a view of dir2. Inode data 212B is associated with stree1clone1 211B and itself is a copy of inode data dir2 212A. Stree1clone1 211B is a clone from stree1 211A.

To determine a modified creation time value through which to filter inode data 212B, the tree identification that inode data 212B is associated with (Stree1clone1) is compared to the ID of the current clone 211C (Stree1clone2). Based on a determination that the two identifications do not match, the instructions cause processing resource 101 to look at the origin ID of 211C. This origin ID identifies the origin directory tree of 211C, which is 211B or stree1clone1. Based on a determination that the origin ID of 211C is the same as the directory tree ID of 212B, the modified creation time value is determined to be origin epoch 200, which is the time value at which the stree1clone1 was created. Accordingly, a relevancy of the entries in inode data 2 copy may be determined via the birth epoch of the entry, death epoch of the entry, and the modified creation epoch of 200.

In FIG. 2D, the current clone stree1clone3 is represented by portion D with block 213D. The “origin” of the current clone is represented by portion C with block 213C, the “grand origin” of the current clone is represented by portion B with block 213B, and the “great-grand origin” of the current clone is represented by portion A with block 213A. A user of clone stree1clone3 is trying to view dir2 but is not modifying dir2. Accordingly, instead of copying the inode data for dir2 212B, instructions on computing device 100 may cause processing resource 101 to access and read inode data 214B to provide the user a view of dir2. Inode data 212B is associated with stree1clone1 211B and itself is a copy of inode data dir2 212A.

To determine a modified creation epoch, the tree identification that inode data 212B is associated with (Stree1clone1) is compared to the ID of the current clone 213D (Stree1clone3). Based on a determination that the two identifications do not match, instructions cause processing resource 101 to look at the origin ID of 213D. This origin ID identifies the origin directory tree of 213D, which is 213C or stree1 clone2. As compared to FIG. 2C, in FIG. 2D, inode data dir2 214B is being shared amongst stree1clone1 213B, stree1clone2 213C, and stree1clone3 213D. Thus, the example in FIG. 2D is different than the example in FIG. 2C because inode data dir2 214B was not created for directory tree 213C but created for directory tree 213B. Accordingly, the tree identification of inode data 214B (stree1clone1) will not match the origin ID for directory tree 213D (stree1clone2). Based on a determination that the two identifications do not match, instructions cause processing resource 101 to look at the origin ID of Stree1clone2 (stree1clone1). Based on a determination that the origin ID of 213C is the same as the Stree ID of 213B, the modified creation epoch is determined to be origin epoch 200, which is the epoch at which the stree1clone1 was created. Accordingly, a relevancy of the entries in inode data dir2 copy may be determined via the birth epoch of the entry, the death epoch of the entry, and the modified creation epoch of 200.

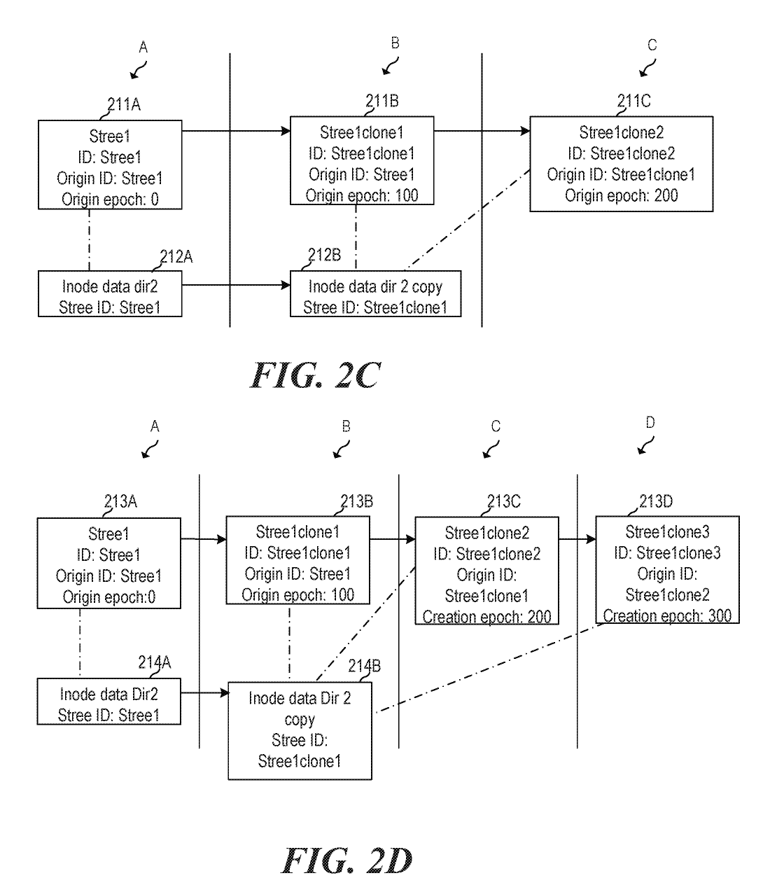

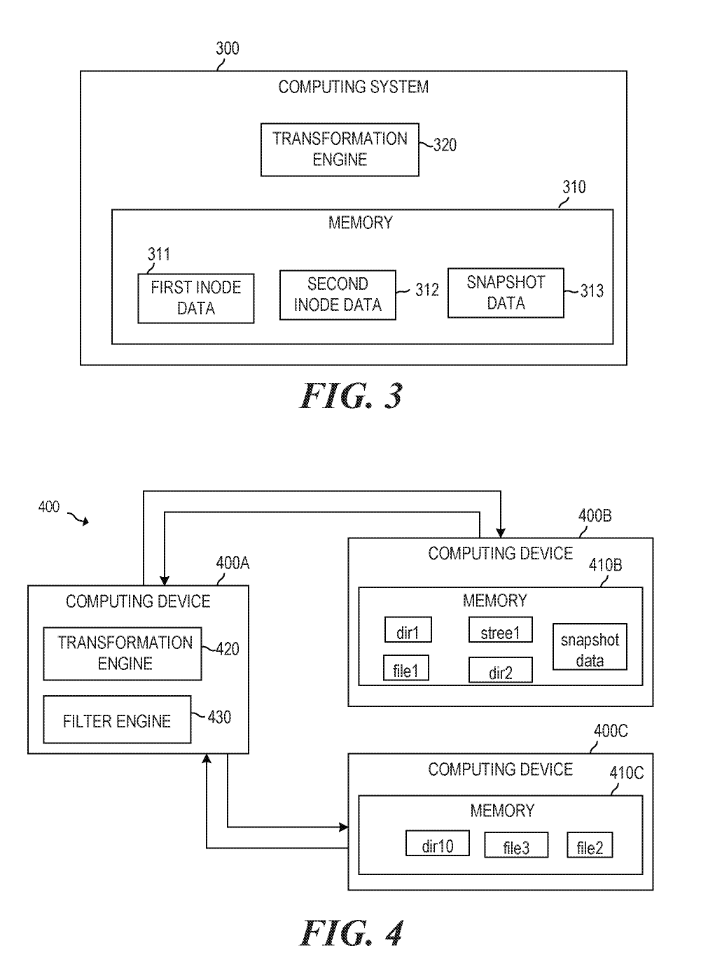

Computing device 100 of FIG. 1, which is described in terms of processors and machine readable storage mediums, may include one or more aspects of computing system 300 of FIG. 3 or computing system 400 of FIG. 4, which are described in terms of engines having hardware and software.

FIG. 3 is a block diagram of a computing system 300 with a directory tree and an engine to clone the directory tree. As used herein, “a computing system” may include at least one computing device (including at least two computing devices). In examples, where the computing system includes at least two computing devices, the at least two computing devices may be communicatively connected to each other through a communication network to exchange data, commands, and information. In some examples, the communication network may be a wireless network, a wired network, or a combination thereof. In some examples, the communication network may be an individual network or a collection of many such individual networks interconnected with each other and functioning as a single large network (e.g., the Internet or an intranet). In some examples, the communication network may be implemented as a local area network (LAN), wide area network (WAN), etc. Computing system 300 may include a transformation engine 320 and a memory 310. Memory 310 may be implemented by a machine-readable storage medium, as described above in relation to storage medium 110.

Engine 320 and any other engines, may be any combination of hardware (e.g., a processor such as an integrated circuit or other circuitry) and software (e.g., machine or processor-executable instructions, commands, or code such as firmware, programming, or object code) to implement the functionalities of the respective engine. Such combinations of hardware and programming may be implemented in a number of different ways. A combination of hardware and software can include hardware (i.e., a hardware element with no software elements), software hosted on hardware (e.g., software that is stored in a memory and executed or interpreted by a processor), or by hardware and software hosted on hardware. Additionally, as used herein, the singular forms “a,” “an,” and “the” include plural referents unless the context clearly dictates otherwise. Thus, for example, the term “engine” is intended to mean at least one engine or a combination of engines. In some examples, computing system 300 may include additional engines, like some of the engines discussed in relation to computing device 400.

Engine 320 of computing system 300 can include at least one machine-readable storage mediums (for example, more than one) and at least one processing resource (for example, more than one). For example, software that provides the functionality of engines on computing system 300 can be stored on a memory of a computer to be executed by a processing resource of the computer. In some examples, engine of computing system 300 may include hardware in the form of a microprocessor on a single integrated circuit, related firmware, or other software for allowing the microprocessor to operatively communicate with other hardware of computing system 300.

Transformation engine 320 is an engine of computing system 300 that includes a combination of hardware and software that allows computing system 300 to receive a request for a clone of a directory tree stored on memory 310. The directory tree may be described by first inode data 311 and second inode data 312. As discussed above, the request may be for a clone of the directory tree at a specific point in time. This specific point in time may be characterized as the “first” point in time. In some examples, the specific point in time of the directory tree is captured by a particular snapshot. The snapshot may be associated with a creation time value that may characterize the first point in time. The creation time value and snapshots of computing system 300 may be stored in snapshot data 313 on memory 310. In some examples, the creation time value is a creation epoch.

Transformation engine 320 also allows computing system 300 to generate a copy of the first inode data 311. In some examples, the first inode data 311 may describe a root of the directory tree that is stored on memory 310. A directory tree root, as described above in relation to FIGS. 1-28, is applicable here. The first inode data 311 may include a number of entries, including a first entry. As used herein, a “number” may include one, two, three, etc. The entries may describe directories of the directory tree and files of the directory tree. Each entry may also be associated with an object name, an inode number, a birth time value, and a death time value. In some examples, the birth time value is a birth epoch. In some examples, the death time value is a death epoch. The inode number may point to a portion of a data block where the underlying data for the entry is stored. In some examples, the first inode data may also include identifying information such a tree identification. The tree identification may tie the first inode data to a specific directory tree. As discussed above in relation to FIG. 1, the first inode data 311 may describe the directory tree at a point in time that is different from the first point in time.

Accordingly, transformation engine 320 determines a relevancy of an entry in the first inode data 311 based, at least in part, a comparison of the birth time value of the first entry and the creation time value of the first point in time. In some examples, transformation engine 320 determines a relevancy based, at least in part, a comparison of the creation time value of the first point in time with the death time value of the first entry. The description above with regard to instructions 113 of FIG. 1 is applicable here.

Transformation engine 320 may also allow computing system 300 to modify the copy of the first inode data 311 based on the relevancy determination. An entry that is determined to be irrelevant may be deleted from the copy. Additionally, a relevant entry may be modified to make the entry accurate in view of the first point in time. For example, an entry in the first inode data with a death epoch that marks the first entry as being inactive may be modified such that the entry is shown as being active in the first inode data copy. Memory 310 may store the modified copy of the first inode data.

Second inode data 312 may describe a portion of the directory tree. For example, first inode data 311, which describes the root of the directory tree, may include a first entry for a directory of the directory tree. Second inode data may describe the contents of that directory and may have entries for sub-directories and/or files in that directory. The directory tree stored by computing system 300 may have additional inode data that is not shown in FIG. 3. The additional inode data may describe other portions of the directory trees, such as other directories, subdirectories, and/or files. In some examples, transformation engine 320 may allow computing system 300 to copy second inode data 312 and/or additional inode data of the directory tree, determine the relevancy of entries in the copied inode data, and modify the copied inode data based on the relevancy. Thus, in some examples, transformation engine 320 may copy and modify the inode data that describes the entire directory tree to generate a clone of the directory tree.

In some examples, the clone that is generated is writeable and a user may use it as needed. In some examples, for quicker access to the directory tree clone, computing system 300 may allow a user to access and modify the directory tree clone before the relevancy determination is completed.

Computing system 300 of FIG. 3, which is described in terms of engines with hardware and software, may include one or more aspects of computing system 400 of FIG. 4 or computing device 100 of FIG. 1.

FIG. 4 is a block diagram of a computing system 400 with a distributed file system having the directory tree of FIG. 2A. Computing system 400 includes computing device 400A, computing device 400B, and computing device 400C. Computing device 400A, computing device 400B, and computing device 400C communicate to each other through a network, as discussed above. Computing devices 400A, 400B, and 400C may each be a server, computer networking device, chip set, desktop computer, workstation, personal device, or any other processing device or equipment. Computing device 400B has a memory 410B and computing device 400C has a memory 410C. Memories 410B and 410C may be implemented by a storage medium, as described above.

Memory 410B may store inode data for a portion of the directory tree of FIG. 2A, such as inode data for dir1, stree1 (i.e. the root of the directory tree), dir2, and file1. The inode data for dir1, stree1, and dir2 may include entries that describe the respective directories. Memory 410B may also snapshot data for snapshots of the directory tree. Memory 410C may store inode data for another portion of the directory tree of FIG. 2A, such as inode data for dir10, file3, and file2.

Computing device 400A includes a transformation engine 420 and a filter engine 430. Engines 420, 430, and any other engines, may be any combination of hardware (e.g., a processor such as an integrated circuit or other circuitry) and software (e.g., machine or processor-executable instructions, commands, or code such as firmware, programming, or object code) to implement the functionalities of the respective engine. Such combinations of hardware and programming may be implemented in a number of different ways. A combination of hardware and software can include hardware (i.e., a hardware element with no software elements), software hosted on hardware (e.g., software that is stored in a memory and executed or interpreted by a processor), or by hardware and software hosted on hardware. In some examples, computing system 400 may include additional engines.

Engines 420 and 430 of computing system 300 can include at least one machine-readable storage mediums (for example, more than one) and at least one processing resource (for example, more than one). For example, software that provides the functionality of engines on computing system 400 can be stored on a memory of a computer to be executed by a processing resource of the computer. In some examples, engine of computing system 400 may include hardware in the form of a microprocessor on a single integrated circuit, related firmware, or other software for allowing the microprocessor to operatively communicate with other hardware of computing system 400.

Transformation engine 420 is similar to transformation engine 320 and the description of transformation engine 320 is applicable here.

Filter engine 430 is an engine of computing device 400A that includes a combination of hardware and software that allows computing system 400 to read an inode data and determine the relevancy of the entries in the inode data based on a modified creation epoch. As discussed above, the directory tree of computing system 400 may include numerous directories and/or subdirectories. In some examples, a user does not need to modify every directory and subdirectory in the directory tree and only needs to view the unmodified portions. Thus, filter engine 430 allows computing device 400A to read the inode data describing the unmodified portions. Reading the inode data of the portions that are not modified allows for faster clone creation of the directory tree as compared to copying the inode data for all portions of the directory tree.

Because the inode data that is being read may include entries that are not relevant to current clone, a relevancy of the entries in the inode data to the current clone is determined based on a modified creation epoch. In some examples, filter engine 430 allows computing system 400 to determine the modified creation epoch based, at least in part, on a tree identification associated with the inode data that is being read. For example, a user creating a clone of the directory tree may want to modify dir1 but not modify dir2. Accordingly, transformation engine 420 may make a copy of the inode data for dir1 and filter engine 430 may read the inode data for dir2. The inode data for dir2 has a tree identification that identifies which directory tree the inode data was created for. Filter engine 430 may compare this tree identification with the identification of the current directory tree clone. Based on the determination that the two are a match, the creation epoch of the current directory tree clone is used as the modified creation epoch. Based on a determination that the two are not a match, filter engine 430 may look at the origin directory tree of the current directory tree clone. Filter engine 430 may compare the tree identification listed in the inode data with the identification of the origin of the directory tree clone. Based on the determination that the two are a match, the origin epoch of the origin directory tree is used as the modified creation epoch. Based on a determination that the two are not a match, filter engine 430 may look at the grand origin of the current directory tree clone. Filter engine 430 may look at the entire clone line of the directory tree (e.g., great-grand origin, etc.) to find a directory tree that matches the tree identification listed in the inode data being read. In some examples, computing system 400 may include a table that keeps track of directory trees, the origin directory tree of the directory tree (i.e. the origin identification), and the creation time value of the origin directory tree (i.e. the origin time value).

Filter engine 430 also allows computing system to determine a relevancy of the entries in the inode data that is being read. In some examples, the relevancy of the entries is based, at least in part, a comparison of the birth epoch of the entry and the death epoch of the entry to the modified creation epoch. For example, if the birth epoch of an entry represents a time that is later than the time of the modified creation epoch, then the entry is not relevant to the clone because the file or directory associated with the entry was created after desired time of the clone. As another example, if the birth epoch of the an entry represents a time that is earlier than the time of the modified creation epoch, then the entry is relevant to the clone because it was created before and existed at the desired time of the clone.

As another example, if the death epoch of the entry represents a time that is before the time of the modified creation epoch, then the entry is not relevant to the clone because the file or the directory associated with the entry was rendered inactive before the first point in time. As another example, if the death epoch of the entry represents a time that is later than the time of the modified creation epoch, or if the death epoch of the entry represents that the entry has not been killed, then the entry is relevant to the clone because it was still in existence at the time of the clone.

Filter engine thus allows computing system 400 to filter out entries that are not relevant when performing a read command on the inode data that is not copied. In some examples, inode data that is first read by filter engine when the done is requested may be later copied by transformation engine 420. This is because, at first, a user may not need to modify a certain portion of the directory tree when creating the clone and may later need to modify that portion. Thus, when the user needs to modify it, the transformation engine 420 may copy the inode data that describes that portion of the directory tree, determine a relevancy of the entries in the inode data, and modify the copy of the inode data based on the relevancy determination.

In some examples, transformation engine 420 may also allow computing system 400 to modify the inode data to include a table that keeps track of copies made from that inode data for a specific directory tree clone. This allows computing system 400 to access the correct version of the inode data without updating the entire directory tree. For example, an inode data for a directory may have an entry for a subdirectory. The entry for the subdirectory will have an inode number that points to an inode data that describes the subdirectory. However, the inode data that the entry points to may be outdated, as there may a copy of the inode data for the subdirectory for a particular clone. Thus, transformation engine 420 may modify the original inode data for the subdirectory to include a table that indicates there is a copy of the inode data that exists for a specific clone. Accordingly, when accessing that subdirectory in that specific clone, the transformation engine 420 or the filter engine 430 may first access the original inode data for the subdirectory and perform a lookup to determine if there is a copy of that inode data that exists for that specific clone. Based on a determination that a copy exists, transformation engine 420, filter engine 430, or any other engine that may be re-directed to the copy of the inode data. In some examples, this table may be characterized as a pointer to the copy of the inode data.

In some examples, computing system 400 may have additional engines not shown in FIG. 4. Computing system 400 of FIG. 4, which is described in terms of engines with hardware and software, may include one or more aspects of computing system 300 of FIG. 3 or computing device 100 of FIG. 1.

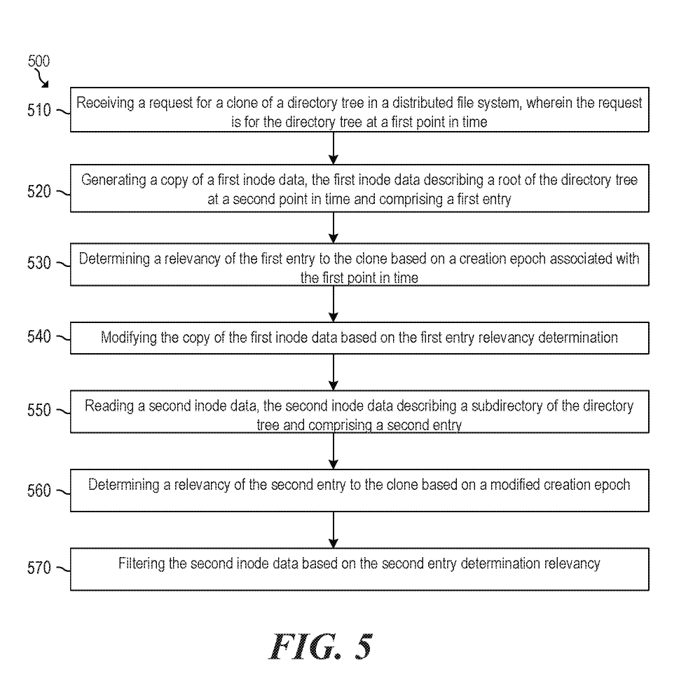

FIG. 5 illustrates a flowchart for a method 500 to generate a clone of a directory tree. Although the execution of method 500 is described below with reference to computing system 400 of FIG. 4 other suitable systems for execution of method 500 may be utilized (e.g., computing device 100 or computing system 300). Additionally, implementation of method 500 is not limited to such examples and method 500 may be used for any suitable device or system described herein or otherwise.

At 510 of method 500, transformation engine 420 receives a request for a clone of a directory tree of computing system 400. The request may be for the directory tree at a specific point in time. In some examples, this specific point in time may be characterized as a first point in time. In some examples, the directory tree may be captured at the first point in time by a snapshot. The snapshot may be associated to a creation time value that correlates to the first point in time. In some examples, the creation time value may be a creation epoch.

At 520 of method 500, transformation engine 420 generates a copy of an inode data. The inode data may describe a root of the directory tree. As discussed above, the root of the directory tree is the directory tree at its highest level. Thus, in the computing system 400, this inode data root is stree1 stored on memory 410B. The root inode data describes the directory tree at a point in time that is different from the first point in time. This different point in time may be characterized as a second point in time. The inode data root may include an entry that describes a directory and/or file of the directory tree. This entry may be characterized as a first entry. In some examples, the entry may include an object name, a birth time value, a death time value, and an inode number. The inode number may lead to another inode data stored in memory of computing system 400 that describes the entry.

At 530 of method 500, transformation engine 420 determines a relevancy of the entry to the clone. In some examples, this may be determined based, at least in part, in the creation time value that is associated with the first point in time. In some examples, this relevancy determination may also be based, at least in part in, the birth time value and the death time value of the entry. An entry that is created after the first point in time is not relevant to the clone. Similarly, an entry that is inactive before the first point in time is not relevant to the clone.

At 540 of method 500, transformation engine 420 modifies the copy of the inode data based on the relevancy determination. In some examples, this includes the removal of the entry from the inode data copy based on a determination that the entry is not relevant to the clone. In some examples, this includes retaining the entry but modifying the entry. For example, an entry in the inode data may indicate that it is created before the first point in time and is removed after the first point in time. The entry may be determined to be relevant to the clone. Thus, transformation engine 420 does not remove the entry. However, transformation engine 420 may modify the death time value associated with the entry in the inode data copy to indicate that the entry is still active in the current clone (i.e., modifying a death time value of 400 to a value of −1 when viewing from a creation epoch of 200).

At 550 of method 500, filter engine 430 may read a second inode data of the directory tree of computing system 400. The second inode data may describe a portion of the directory tree. In some examples, the portion may be a directory (e.g., dir1 or dir2) of the directory tree. In some examples, the portion may be a subdirectory (e.g., dir10) of the directory tree. The portion of the directory tree may be a portion that is not modified by a user of the directory tree clone. In other words, a user of the directory tree may only want to view this portion of the directory tree. The second inode data may comprise an entry that describes a file or a subdirectory of that directory. This entry may be characterized as a second entry in relation to the first entry. In some examples, the second inode data describes the portion of the directory tree at a point in time that is different from the point in time of the requested clone. The point in time related to the second inode data may be the same or different from the point in time that is related to the first inode data.

Because the second inode data describes the directory tree portion at a different point in time than at the point in time of the requested clone, at 560 of method 500, filter engine 430 may determine a relevancy of the second entry to the clone. In some examples, this determination may be made based, at least in part, on a modified creation epoch, a birth time value of the second entry, and a death time value of the second entry, as described above.

At 570 of method 500, filter engine 430 may filter the second inode data based on the relevancy determination of 560. Accordingly, filter engine 430 filters out any entries in the second inode data that is irrelevant to the clone. The user of the clone when viewing the director tree does not see files, directories, and/or subdirectories that are determined to be irrelevant. Accordingly, the user of the clone views the directory tree as it existed at the first point in time.

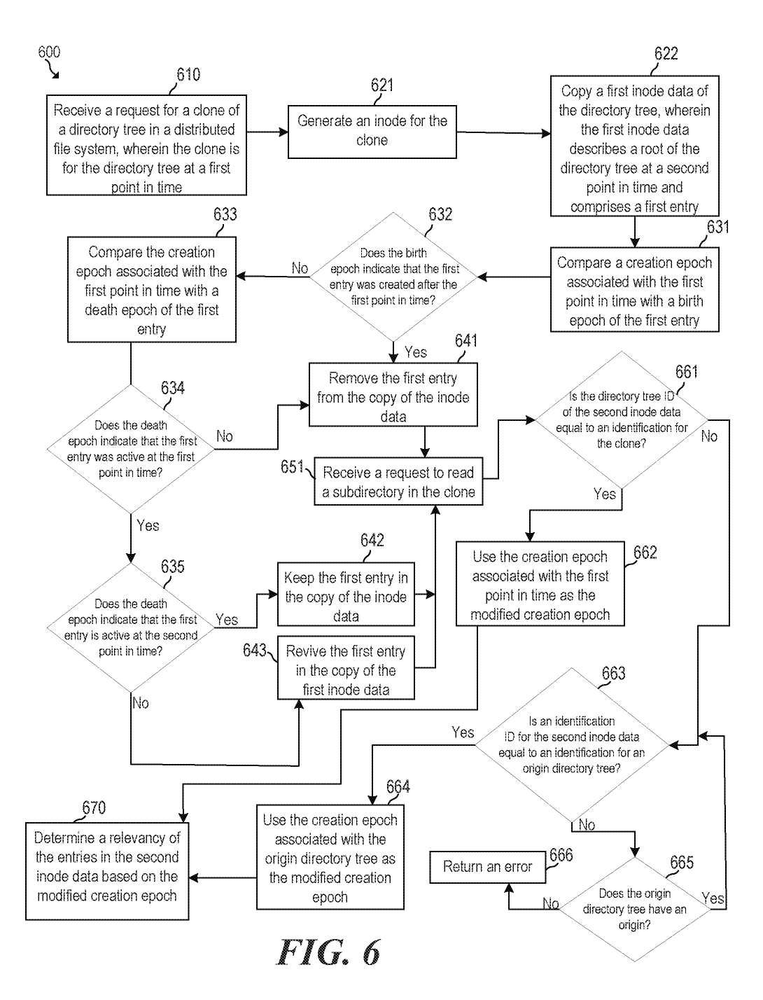

Although the flowchart of FIG. 5 shows a specific order of performance of certain functionalities, method 500 is not limited to that order. For example, some of the functionalities shown in succession may be performed in a different order, may be executed concurrently or with partial concurrence, or a combination thereof. In some examples, functionalities described herein in relation to FIG. 6 may be provided in combination with functionalities described herein in relation to any of FIGS. 1-4, and 6. Additionally, although FIG. 5 describes only a first inode data describing a root of the directory tree and a second inode data describing a portion of the directory tree, the method of FIG. 5 may be performed on any inode data of the directory tree. For example, the transformation engine 420 may copy and modify inode data of any portion of the directory tree that the user will modify and filter engine 430 may read and filter any portion of the directory tree that the user needs to view but not modify.

FIG. 6 illustrates a flowchart for a method 600 to determine relevancies of entries in inode data. Although the execution of method 600 is described below with reference to computing system 400 of FIG. 4 other suitable systems for execution of method 600 may be utilized (e.g., computing device 100 or computing system 300). Additionally, implementation of method 500 is not limited to such examples and method 600 may be used for any suitable device or system described herein or otherwise.

610 of method 600 is similar to 510 of method 500. Thus, descriptions in relation to 510 are also applicable to 610.

At 621 of method 600, transformation engine 420 may generate an inode for the clone. The inode may be for the root of the directory tree and may include metadata for the directory tree, including an origin identification (i.e. which directory tree the current clone is generated from), and an origin time value. The inode may also include user permissions, etc. for the root and an inode number pointing to inode data that describes the directory tree.

At 622 of method 600, transformation engine 420 may copy a first inode data of the directory tree. The first inode data describes a root of the directory tree at a different point in time than the first point in time of step 610. The first inode data may also comprise a number of entries, including a first entry, for directories and/or files in the directory tree. The inode number described above in relation to 621 may point to this copy of the first inode data.

631-635 of method 600 may relate to a relevancy determination of the entries in the copy of first inode data. At 631 of method 600, transformation engine 420 may compare a creation time value that is associated with the first point in time with a birth time value of the first entry. At 632 of method 600, transformation engine 420 determines if the birth time value of the first entry indicates that the first entry was created after the first point in time. For example, the birth time value and the creation time value may be based on epochs. Because an epoch is an ever increasing number in the computing system 400, an epoch value that is higher than another epoch value indicates that the higher epoch value occurred after the lower epoch value. Thus, a first entry with a birth epoch of 300 indicates that it was created after a creation epoch of 200. Based on a determination that the birth time value indicates that the first entry was created after the first point in time, transformation engine 420 determines that the first entry is not relevant to the clone and moves to 641. At 641, transformation engine 420 removes the first entry from the copy of the inode data.

Based on a determination that the birth time value indicates that the first entry was created before the first point in time, method 600 moves to 633. At 633, transformation engine 420 compares the creation time value associated with the first point in time to the death time value of the first entry. At 634, transformation engine 420 determines if the death time value indicates that the first entry was active at the first point in time. For example, the death time value and the creation time value may be based on epochs. Because an epoch is an ever increasing number in the computing system 400, an epoch value that is higher than another epoch value indicates that the higher epoch value occurred after the lower epoch value. Thus, a first entry with a death epoch of 300 indicates that it is inactive compared to a creation epoch of 400. On the other hand, a first entry with a death epoch of 500 indicates that it is active compared to a creation epoch of 400. Based on a determination that the death time value indicates that the first entry is not active at the first point in time, method 600 moves to 641. At 641, transformation engine 420 modifies the copy of the first inode data to remove the first entry.

Based on a determination that the death time value indicates that the first entry is active at the first point in time, method moves to 635. At 635, transformation engine 420 determines if the death time value of the first entry indicates that it is active as the entry is listed in the inode data. In other words, at 635, transformation engine 420 determines if the first entry is currently listed as active or inactive. Based on the determination that the first entry is listed as active, method 600 moves to 642. At 642, transformation engine 420 retains the first entry in the copy of the inode data without changing the first entry.

Based on the determination that the first entry is listed as inactive (i.e. the first entry was active at the first point in time but is now listed as being inactive in the inode data) method 600 moves to 643. At 643, transformation engine 420 modifies the first entry in the copy of the inode data to revive the first entry. For example, in the original inode data, the first entry may have had a death epoch of 500. In a clone with a creation epoch of 400, the first entry should still be active. Thus, transformation engine 420 may modify the death epoch of the first entry to indicate that it is active in the copy of the inode data by changing 500 to −1 because a −1 death epoch indicates that the entry is still active.

At 651 of method 600, filter engine 430 receives a request to read a portion of the directory tree clone. In some examples, the portion may be a subdirectory or a directory. In other words, a user of the directory tree clone may want to view the contents of a directory or subdirectory in the directory tree without modifying the directory or subdirectory. Filter engine 430 may access the inode and the inode data associated with that portion of the directory tree without making a copy of the inode and the inode data. The inode data that is associated with that portion of the directory tree may be characterized as a second inode data. Because the second inode data accessed may or may not accurately represent the directory tree at the first point in time, filter engine may determine a relevancy of entries in the second inode data based on a modified creation time value. Steps 661-666 are related to the determination of the modified creation time value.

At 661, filter engine 430 determines if the tree identification listed in the second inode data is equal to the identification of the current clone. As discussed above, clones may be identified to the computing system with unique alphanumeric characteristics. Additionally, inodes and inode data for different directories or subdirectories of the directory tree may be associated to the directory tree clone for which they were created. Filter engine 430 recognizes which clone of the directory tree the user is operating in and thus compares the ID associated with the current clone with the tree identification stored in the second inode data. In response to the determination that the IDs match, method proceeds to 662. At 662, filter engine 430 uses the creation time value of the first point in time as the modified creation time value. This is because the matching of the inode data directory tree ID and the current operating directory tree ID indicates that the inode data being read was generated for the current clone.

Referring back to 661, in response to the determination that the do not IDs match, method proceeds to 663. At 663, filter engine 430 checks the identification of the origin directory tree (i.e. an origin identification) to see if the identification of the origin directory tree matches the tree identification indicated in the second inode data. In response to a determination that the identification of the origin directory tree matches the tree ID listed in the second inode data, method 600 proceeds to 664. At 664, filter engine 430 uses the creation time value associated with the origin directory tree (i.e., an origin time value) as the modified creation time value.

Referring back to 663, in response to a determination that the IDs do not match, method 600 proceeds from 663 to 665. At 665, filter engine 430 may determine if the origin directory tree of the current directory clone itself has an origin. In other words, filter engine 430 determines if the origin directory tree is a clone of another directory tree. In response to a determination that the origin directory tree is itself a clone, method 600 goes back to 663. At 663, filter engine 430 determines if the tree identification associated with the second inode is a match to the identification of the origin of the origin directory tree (i.e. a grand origin of the current directory tree clone). Based on a determination that there is a match, method 600 proceeds to 664. Based on a determination that is not a match, method 600 goes back to 665. This time, filter engine 430 determines if the grand origin of the current directory tree has a parent origin (i.e. a great-grand origin of the current directory tree). Thus, 663 and 665 may be characterized as a loop that keeps moving up the clone line of the current directory tree clone as long as there is no match with the tree identification listed in the second inode data. The loop may end when there is a match (when the method may proceed to 664) or when there is no longer any other clones in the “clone line”. Based on a determination that there is not another parent in the clone line of the current directory tree clone, method may proceed to 666 where there is an error that is returned to the user. As discussed above, filter engine 430 may rely on a table that is stored on a memory of computing system 400 that associates directory trees to their direct origin. Thus, filter engine 430 may look up the identification of the current directory clone and retum the directory tree id of the origin directory tree.

Referring back to 662 and 664, once a modified creation time value is determined by filter engine 430, method 600 proceeds to 670. At 670, filter engine 430 determines a relevancy of the entries in the second inode data based, at least in part, on the modified creation time value determined in either 662 or 664. As discussed above, the relevancy determination may also be based on a birth time value and a death time value of the entries in the second inode data.

Although the flowchart of FIG. 6 shows a specific order of performance of certain functionalities, method 600 is not limited to that order. For example, some of the functionalities shown in succession may be performed in a different order, may be executed concurrently or with partial concurrence, or a combination thereof. In some examples, functionalities described herein in relation to FIG. 6 may be provided in combination with functionalities described herein in relation to any of FIGS. 1-5. Additionally, while FIG. 6 discusses two inode data and a specific number of entries, method 600 is not limited to the number of inode data or entries discussed. For example, a directory tree may have hundreds of directories and/or subdirectories. Each directory and subdirectory has an associated inode data. Using method 600, computing system 400 may determine a relevancy of the entries in each of the directories and/or subdirectories to the directory tree clone.

All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. A non-transitory machine-readable storage medium comprising instructions, that, when executed, cause a processing resource to:
receive a request for a clone of a directory tree in a distributed file system, wherein request is for the clone to represent the directory tree as it existed at a first point in time;
in response to the request, generate a copy of inode data, the inode data describing a root of the directory tree at a second point in time and comprising a first entry; and
determine a relevancy of the first entry to the clone based on a birth epoch and a death epoch of the first entry.

2. The non-transitory machine-readable storage medium of claim 1,
wherein the first point in time is associated with a creation epoch; and
wherein the determination of the relevancy of the first entry is based on a comparison of the creation epoch, the birth epoch, and the death epoch.

3. The non-transitory machine-readable storage medium of claim 1,
wherein the copy is generated using a snapshot of the directory tree at the first point in time.

4. The non-transitory machine-readable storage medium of claim 1, comprising instructions, that, when executed, cause the processing resource to modify the copy of the inode data to exclude the first entry in response to a determination that the first entry is irrelevant.

5. The non-transitory machine-readable storage medium of claim 1,
wherein the first entry is inactive at the second point in time and active at the first point in time.

6. The non-transitory machine-readable storage medium of claim 5, comprising instructions, that, when executed, cause the processing resource to modify the copy of the inode data to indicate that the first entry is active.

7. The non-transitory machine-readable storage medium of claim 6,
wherein the modification is to the death epoch of the first entry.

8. The non-transitory machine-readable storage medium of claim 1,
wherein the directory tree comprises a subdirectory described by a subdirectory inode; and
wherein the non-transitory machine-readable storage medium comprises instructions, that, when executed, cause the processing resource to determine a modified creation epoch for the subdirectory inode.

9. The non-transitory machine-readable storage medium of claim 8, comprising instructions, that, when executed, cause the processing resource to filter the subdirectory inode using the modified creation epoch.

10. A computing system comprising:
a memory to store first inode data and second inode data of a directory tree;
wherein the first inode data describes a root of the directory tree at a first point in time and comprises a first entry; and
wherein the second inode data describes a first portion of the directory tree; and
a transformation engine to:
receive a request for a clone of the directory tree, wherein the request is for the clone to represent the directory tree at a second point in time;
in response to the request, generate a copy of the first inode data; and
determine a relevancy of the first entry to the clone based on a birth epoch and a death epoch of the first entry.

11. The computing system of claim 10,
wherein the transformation engine is to modify the copy of the first inode data based on the relevancy of the first entry.

12. The computing system of claim 10,
wherein the second inode data comprises a second entry and is associated with a tree identification; and
wherein the computing system comprises a filter engine to:
receive a read request of the second portion;
determine a modified creation epoch based on the tree identification; and
determine a relevancy of the second entry to the clone based on the modified creation epoch.

13. The computing system of claim 12,
wherein the directory tree is associated with an origin identification; and
wherein the determination of the modified creation epoch is based on the origin identification.

14. The computing system of claim 10, wherein the request is based on a snapshot of the directory tree at the second point in time.

15. The computing system of claim 10, wherein the second point in time is associated with a creation epoch and the relevancy of the first entry is based on the creation epoch.

16. The computing system of claim 10, comprising:
a first server to store the first portion of the directory tree; and
a second server to store a second portion of the directory tree.

17. A method comprising:
receiving a request for a clone of a directory tree in a distributed file system, wherein the request is for the clone to represent the directory tree at a first point in time;
in response to the request, generating a copy of first inode data, the first inode data describing a root of the directory tree at a second point in time and comprising a first entry;
determining a relevancy of the first entry to the clone based on a creation epoch associated with the first point in time;
modifying the copy of the first inode data based on the relevancy determination for the first entry;
reading second inode data, the second inode data describing a subdirectory of the directory tree and comprising a second entry;
determining a relevancy of the second entry to the clone based on a modified creation epoch; and
filtering the second inode data based on the relevancy determination for the second entry.

18. The method of claim 17,
wherein the first entry comprises a birth epoch and a death epoch; and
wherein the relevancy determination for the first entry is based on the birth epoch and the death epoch.

19. The method of claim 17, comprising determining the modified creation epoch based on an origin identification associated with an origin directory tree of the clone.

20. The method of claim 17, comprising generating a pointer in the first inode data of the directory tree to the copy of the first inode data.
